(19) United States
(12) Patent Application Publication
(10) Pub. No.: US 2003/0122370 A1
(43) Pub. Date: Jul. 3, 2003

(54) Method and system for labeling and scheduling medicament dosages

(76) Inventor: Mary Elizabeth Goddard, McFarland, WI (US)

Correspondence Address: Michael Best & Friedrich LLP, 100 East Wisconsin Avenue, Milwaukee, WI, 53202-4108, US

(21) Appl. No.: 10/041,134

(22) Filed: Jan. 8, 2002

Related U.S. Application Data
(63) Continuation-in-part of application No. 10/034,988, filed on Dec. 28, 2001.

(51) Int. Cl. B42D 15/00

(52) U.S. Cl. 283/81

(57) ABSTRACT

The invention provides a device for providing medicament use information including an affixable label selectively mountable to a portion of a medicament container. The affixable label has a perimeter. A plurality of preprinted lines are positioned on the affixable label. One of the plurality of preprinted lines relates to dosage of the medicament and a second of the plurality of preprinted lines relates to the type of medicament within the medicament container. The invention also provides a method of tracking a schedule of taking medicaments. The method includes completing information on a preprinted affixable label, placing the label on a portion of a medicament container, and placing a second label over the first label upon the occurrence of a predetermined condition.

### RELATED APPLICATIONS

This application is a continuation-in-part of application No. ______, filed on Dec. 28, 2001, entitled “Method and System For Labeling and Scheduling Medicament Dosages.”

### FIELD OF THE INVENTION

The present invention relates to a method and system for labeling and scheduling medicament (defined below) dosages. More particularly, the present invention relates to an affixable label mounted to a medicament container for providing medicament use information and methods of using the same.

### BACKGROUND OF THE INVENTION

In today's world, people consume large amounts of medicaments to maintain and increase their health. As used herein, the word medicament includes any preventative, curative, or supplement substance that a person ingests or otherwise introduces into his or her body for health or well being purposes, regardless of clinically proven efficacy. With the large amounts of medicaments being consumed, it becomes difficult to remember a consumption schedule for each medicament. It is important for people to remember consumption schedules, especially when taking prescription medicaments. A person may become ill or even overdose on prescription medicaments if too little or too much medicament is consumed. Further, a person other than the person taking the medicament, such as a day care worker, nurse, or other individual, may be responsible for ensuring proper dispensing of the medicament. In response to this problem, numerous scheduling devices have been developed to ease the difficulty of remembering consumption schedules.

Some scheduling devices have been designed from plastic or other material and attach to the exterior of a medicament container. Scheduling devices that attach to the exterior of medicament containers typically have many pieces and include a sliding or twisting member that highlights a date or time of day that the medicament should be consumed. However, scheduling devices attached to the exterior of the medicament containers are often bulky and can easily break. Pieces of the scheduling devices also protrude from the container and can snag other items or fall off of the container and be lost. Scheduling devices designed of plastic or other materials for attachment to medicament containers are also relatively expensive. Costs can add up quickly when purchasing these scheduling devices for each medicament container possessed by a consumer.

Yet other scheduling devices have been used to ease the difficulty of remembering a medicament consumption schedule, such as, manually written schedules, which are separate from the medicament container. However, written schedules are often lost or misplaced.

### SUMMARY OF THE INVENTION

Accordingly, there is a need for an improved medicament scheduling device. The invention provides a device for providing medicament use information including an affixable label selectively mountable to a portion of a medicament container. As used herein, the word affixable includes any adhesive or cohesive method of placing the label on a medicament container. The affixable label has a perimeter. A plurality of preprinted lines are positioned on the affixable label. One of the plurality of preprinted lines relates to the dosage of the medicament, and a second of the plurality of preprinted lines relates to the type of medicament within the medicament container.

According to another aspect, the invention provides a device for providing medicament use information including an affixable label selectively mountable to a portion of a medicament container. The affixable label has a perimeter. A plurality of preprinted lines are positioned on the affixable label. One of the plurality of preprinted lines relates to a date, a second of the preprinted plurality of lines relates to a time, a third of the plurality of preprinted lines relates to the type of medicament, and a fourth of the plurality of preprinted lines relates to the dosage of the medicament.

According to yet another aspect, the invention provides a device for providing medicament use information including an affixable label selectively mountable to a portion of a medicament container. The affixable label has a perimeter. A plurality of preprinted lines are positioned on the affixable label. One of the plurality of preprinted lines relates to the dosage of the medicament, and a second of the plurality of preprinted lines relates to the type of medicament within the medicament container. A timetable is positioned relatively near to the perimeter and includes a plurality of numbers and an AM or a PM indicator (“AM/PM indicator”). The plurality of numbers and the AM/PM indicator can selectively indicate times of a day that a medicament should be taken.

According to yet another aspect, the invention provides a method of tracking a schedule of taking medicaments. The method includes completing information on a preprinted affixable label, placing the label on a portion of a medicament container, and placing a second label over the first label at a predetermined time or when the information changes. The act of completing information on the label can be accomplished before and/or after the label is placed on the medicament container.

In another embodiment, the invention provides a method of tracking a schedule of taking a medicament. The method includes determining a schedule for taking a medicament, for example, based on a prescription or recommended dosage of a medicament manufacturer. Once the schedule is determined, it is translated or otherwise written or marked upon a first preprinted affixable label, the affixable label having a first side that includes a plurality of preprinted texts, at least two of the preprinted texts having an associated preprinted line, where a first of the at least two preprinted lines relates to a type of the medicament, and a second of the at least two preprinted lines relates to a dosage of the medicament, and a second side operable to be affixed to a portion of a medicament container. Preferably, translating the schedule includes marking at least some of the preprinted texts with at least one first mark to indicate at least one time of day the medicament is to be consumed.

The method also includes marking at least some of the preprinted text with at least one second mark to indicate at least one time of day when the medicament was actually consumed, and placing a second label over the first label when a predetermined condition occurs.

Other features of the invention are set forth in the attached drawings, detailed description, and claims.

### BRIEF DESCRIPTION OF DRAWINGS

FIG. 1 is a perspective view of a scheduling device of the invention.

FIG. 2 is a top view of a backing sheet or holding strip and a plurality of scheduling devices of FIG. 1.

FIG. 3 is a perspective view of a medicament container and the scheduling device of FIG. 1.

FIG. 4 is a perspective view of an alternate embodiment of the invention.

FIG. 5 is a perspective view of another alternate embodiment of the invention.

### DETAILED DESCRIPTION

Before embodiments of the invention are explained, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting. As used herein, the word consumer includes a consumer of a medicament and/or any person assisting the consumer in performing activities related to the consumption of the medicament (e.g., a day care worker, a nurse, and the like).

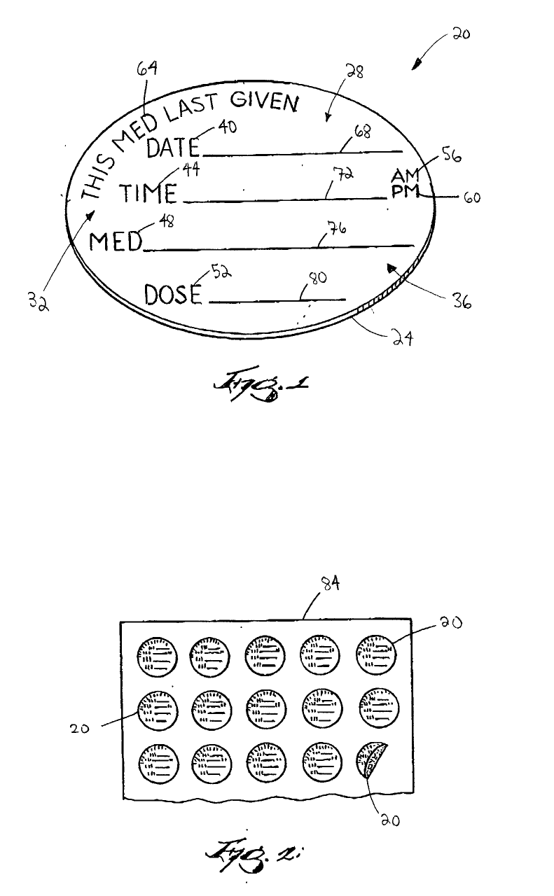

FIG. 1 illustrates a scheduling device 20 embodying the invention. The device 20 has first side 21, and a second side 22 operable to be affixed to a portion of a medicament container (discussed below). The device 20 also has an edge 23 of sufficient thickness (for example, the thickness of a sheet of copy machine/laser printer paper) to permit the device 20 to be peeled from a card, backer sheet, or similar surface. It is also useful that the edge 23 have sufficient thickness so that the device 20 may be grasped or lifted up with a finger or finger nail from a medicament container. The device 20 also has a perimeter 24.

The first side 21 includes preprinted text 32 and preprinted lines 36. The text 32 may include date text 40, time text 44, medicament text 48, dose text 52, AM text 56, PM text 60, and heading text 64, which in the embodiment shown takes the form of a time indicator. The date text 40, time text 44, medicament text 48, and dose text 52 are followed by a date line 68, a time line 72, a medicament line 76, and a dose line 80, respectively. The time line 72 is followed by the AM text 56 and the PM text 60. The AM text 56 is positioned above the PM text 60 (as shown in FIG. 1), but can be arranged in any orientation to the PM text 60, such as, but not limited to, beside the PM text 60, at an angle to the PM text 60, and below the PM text 60. The heading text 64 is positioned near the perimeter 24 and is aligned concentrically with the circular perimeter 24, but may be positioned in any other location on the device 20 and still be within the scope of the invention. The consumer (not shown) manually writes information on the preprinted lines 36 relative to the text 32 preceding the preprinted lines 36. For example, the date is written above the date line 68, the time of day is written above the time line 72, and either the AM text 56 or the PM text 60 is circled or otherwise highlighted depending on whether the time of day is in the morning or afternoon.

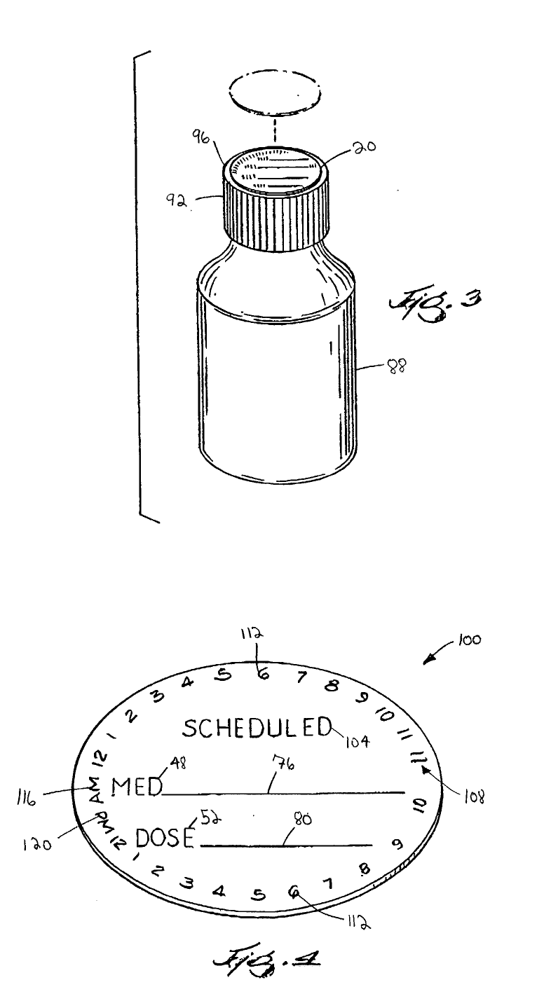

Referring to FIG. 2, the device 20 is initially mounted to a backing sheet or holding strip 84 along with a plurality of similar devices 20. In the preferred embodiment, the devices 20 are affixably mounted to the holding strip 84 and are aligned in linear rows and columns. Although the devices 20 are aligned in linear rows and columns, the devices 20 may be mounted to the holding strip 84 in any pattern and still be within the scope of the invention. The devices 20 can be removed from the holding strip 84 and mounted to a medicament container 88 (see FIG. 3).

Referring to FIG. 3, the device 20 is mounted to a cap 92 of the medicament container 88. Alternatively, the device 20 may be mounted to another location on the container 88 such that the device 20 is readily visible by a person. The affixable side of the device 20 affixably mounts the device 20 to the cap 92 such that no portion of the circular perimeter 24 of the device 20 protrudes beyond a perimeter 96 of the cap 92. The device 20 has the circular perimeter 24 so that the device 20 is complimentary to circular caps. Although the device 20 has the circular perimeter 24 in the preferred embodiment, the device 20 can have a perimeter with any shape, and be complimentary to any shape of cap, and still be within the scope of the invention. Although FIG. 3 illustrates a single device 20 mounted to the container 88, any number of devices 20 may be mounted to the container 88. The devices 20 may be mounted consecutively on top of each other (which is preferred), replaced by removing an old device 20 and mounting a new device 20 in the same or a different location, and the like.

In one embodiment, the device 20 is used each time medicaments are consumed by the consumer to inform the consumer of the last time the medicaments were consumed. A method of operation for the device 20 may include the consumer manually writing relevant information above each preprinted line 36 on the device 20. The writing step may be accomplished while the device 20 is mounted to the holding strip 84, or while the device is mounted to the container 88. The device 20 is removed from the holding strip 84, and affixably mounted to the cap 92 (or some other portion) of the medicament container 88. At a later time, the consumer can refer back to the device 20 on the cap 92, and be informed of the last time the medicaments were consumed.

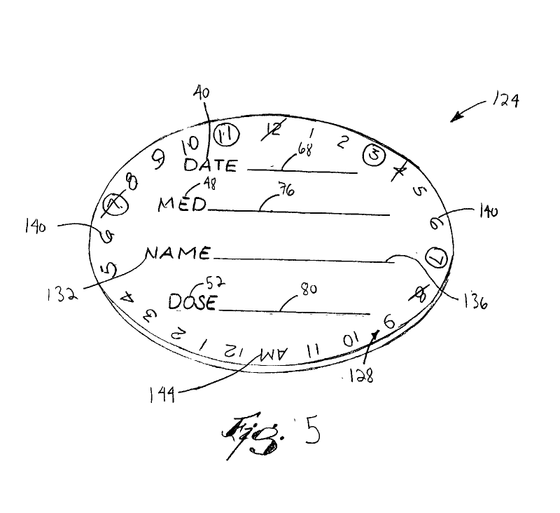

Referring to FIG. 4, an alternate embodiment of the invention, a scheduling device 100, is illustrated. Many of the components in the alternate embodiment are similar to the components in the preferred embodiment. Therefore, like components will be given like reference numbers.

The device 100 includes schedule text 104 and a time indicator in the form or a timetable 108. The timetable 108 includes two sets of numbers 112 ranging from 1 to 12 and an AM/PM indicator in the form of AM text 116 and PM text 120. The timetable 108 allows the consumer to indicate times of the day when the medicament needs to be consumed. The device 100 is affixably mountable to the cap 92 (or some other portion) of the medicament container 88. In this alternate embodiment, the device 100 acts as a schedule and informs the consumer of the times of day that the medicaments need to be consumed. The device 100 only needs to be changed when the schedule changes, unlike the embodiment in which a new device 20 is mounted to the container 88 each time the medicament is consumed.

Referring to FIG. 5, an alternate embodiment of the invention, a scheduling device 124, is illustrated. Many of the components in the alternate embodiment are similar to the components in the previous embodiments. Therefore, like components will be given like reference numbers.

The device 124 includes a timetable 128, name text 132, and a name line 136. The timetable 128 includes two sets of numbers 140 ranging from 1 to 12 and an AM/PM indicator in the form of AM text 144. The timetable 128 allows the consumer to indicate proposed times of the day when the medicament should be consumed. The timetable 128 also allows the consumer to indicate the actual times of day when the medicament is consumed. For example, times at which medicament are to be taken may be circled, and times at which the medicament are actually taken may be marked with an “X”, a “/”, or other mark. In the example shown, the timetable 128 of the device 124 is marked with circles at 7 AM, 11 AM, 3 PM, and 7 PM, indicating a schedule where a dose of the medicament is to be taken every four hours. As the consumer or individual takes the medicament, he or she marks the actual time the medicament was consumed with a “/”. In the example shown, 7 AM, 12 PM, 4 PM, and 8 PM are marked with a “/”, indicating that the consumer took the dosage as intended at 7 AM, likely forgot or missed the 11 AM scheduled dosage, and then continued to consume the remaining dosages for the day every four hours beginning at 12 PM.

Indicating the proposed and actual times on the timetable gives the consumer a daily visual reminder of the time of day the medicament should be consumed, the time of day the medicament was consumed, and/or the time of day the medicament should have been consumed. The name text 132 and the name line 136 are aligned on the device 124 similarly to other texts and lines on previous embodiments. The name or initials of the consumer may be written above the name line 136 to indicate that he or she is supposed to consume the medicaments, and to eliminate any confusion that may occur between medicaments to be taken by different consumers. The device 124 is affixably mountable to the cap 92 of the medicament container 88. The device 124 may be used for one predetermined amount of time, such as a 24-hour period, after which time the device 124 may be replaced or covered by another device 124.

Alternate embodiments of the device 20 can be derived from the embodiments described above and still be covered under the present invention. For example, the preprinted text 32 and lines 36 can be positioned anywhere on the first side 21 of the scheduling device 20, and the name text 132 and name line 136 can be placed on any of the previous embodiments of the device. Additionally, the timetable may include a single set of numbers from 1 to 24 (i.e., military time), to reduce any confusion caused between AM and PM times. Also, the device 20 can be designed in a variety of shapes and sizes, such as oval, square, or rectangular. Other alternative embodiments will be apparent to those skilled in the art and are within the intended scope of the present invention. Thus, the present invention is to be limited only by the following claims.

1. A device for providing medicament use information, the device comprising:
an affixable label having a first side, a second side, and a predetermined thickness, the second side operable to be affixed to a portion of a medicament container, the affixable label having a perimeter;
a time indicator located on the first side of the affixable label, the time indicator indicating at least one time of day corresponding to use of a medicament; and
a plurality of preprinted texts positioned on the first side of the affixable label, at least two of the plurality of preprinted texts having an associated preprinted line, where a first of the at least two preprinted lines relates to a type of the medicament, and a second of the at least two preprinted lines relates to a dosage of the medicament.

2. The device as claimed in claim 1, further comprising a third preprinted line, the third preprinted line relating to a date.

3. The device as claimed in claim 2, further comprising a fourth preprinted line, the fourth preprinted line relating to a time.

4. The device as claimed in claim 3, wherein a majority of the plurality of preprinted texts are orientated for normal top to bottom reading between a top portion of the perimeter and a bottom portion of the perimeter, wherein the preprinted lines are positioned between the top portion and the bottom portion in a descending order such that the third preprinted line is positioned nearest the top portion and is followed in order by the fourth preprinted line, the first preprinted line, and the second preprinted line, such that the second preprinted line is positioned nearest the bottom portion.

5. The device as claimed in claim 1, further comprising heading text positioned relatively near to the perimeter, and relatively concentric with the perimeter.

6. The device as claimed in claim 1, further comprising a timetable positioned adjacent to the perimeter, the timetable including a plurality of numbers and an AM/PM indicator, such that the plurality of numbers and the AM/PM indicator can be marked to selectively indicate the at least one time of day.

7. A device for providing medicament use information, the device comprising:
an affixable label being selectively mountable to a portion of a medicament container, the affixable label having a perimeter; and
a plurality of preprinted lines positioned on the affixable label where a first of the plurality of preprinted lines relates to a date, a second of the plurality of preprinted lines relates to a time, a third of the plurality of preprinted lines relates to a type of a medicament, and a fourth of the plurality of preprinted lines relates to a dosage of the medicament.

8. The device as claimed in claim 7, wherein the plurality of preprinted lines are positioned in a descending order on the device with the first of the plurality of preprinted lines being positioned first and followed in order by the second of the plurality of preprinted lines, the third of the plurality of preprinted lines, and the fourth of the plurality of preprinted lines.

9. The device as claimed in claim 7, further comprising heading text positioned relatively near to the perimeter, and relatively concentric with the perimeter.

10. The device as claimed in claim 7, further comprising an AM indicator positioned generally near the second of the plurality of preprinted lines, the AM indicator operable in conjunction with the second of the plurality of preprinted lines to indicate a time of day.

11. The device as claimed in claim 10, further comprising a PM indicator positioned generally near the second of the plurality of preprinted lines, the PM indicator operable in conjunction with the second of the plurality of preprinted lines to indicate a time of day.

12. The device as claimed in claim 11, wherein the AM indicator is positioned generally above the PM indicator, wherein above is defined in the general direction of normal top to bottom reading.

13. A device for providing medicament use information, the device comprising:
an affixable label being selectively mountable to a portion of a medicament container, the affixable label having a perimeter;
a plurality of preprinted lines positioned on the affixable label, where a first of the plurality of preprinted lines relates to a dosage of the medicament, and a second of the plurality of preprinted lines relates to a type of medicament; and
a timetable positioned relatively near to the perimeter, the timetable including a plurality of numbers, an AM indicator, and a PM indicator, such that, the plurality of numbers, the AM indicator, and the PM indicator can selectively indicate at least one time of day.

14. The device as claimed in claim 13, wherein the plurality of preprinted lines are positioned in a descending order on the device with the first of the plurality of preprinted lines being positioned first, and the second of the plurality of preprinted lines being positioned above the first of the plurality of preprinted lines, wherein above is defined in the general direction of normal top to bottom reading.

15. The device as claimed in claim 13, further comprising scheduled text positioned above the second of the plurality of preprinted lines, wherein above is defined in the general direction of normal top to bottom reading.

16. The device as claimed in claim 13, wherein the plurality of numbers include a first set of numbers ranging from 1 to 12, and a second set of numbers ranging from 1 to 12.

17. The device as claimed in claim 16, wherein the AM indicator and the PM indicator are generally positioned beside each other, the first set of numbers generally positioned beside the AM indicator and extending away from the AM indicator, and the second set of numbers generally positioned beside the PM indicator and extending away from the PM indicator.

18. A method of tracking a schedule of taking medicaments, the method comprising:
completing information on a preprinted affixable label;
placing the label on a portion of a medicament container; and
placing a second label over the first label when a condition selected from a group of an information change and an expiration of a predetermined amount of time occurs.

19. The method as claimed in claim 18, further comprising the act of removing the affixable label from a holding strip after the act of completing information on the preprinted affixable label.

20. The method as claimed in claim 18, wherein the act of completing information on a preprinted affixable label includes completing date information, time of day information, medicament information, and dose information.

21. The method as claimed in claim 18, wherein the act of completing information on a preprinted affixable label is accomplished after the act of placing the label on a portion of a medicament container.

22. The method as claimed in claim 18, wherein the act of completing information on a preprinted affixable label includes completing medicament information, dose information, and timetable information.

23. A method of tracking a schedule of taking medicaments, the method comprising:
completing information on a preprinted circular shaped affixable label;
placing the label on a portion of a medicament container; and
repeating the steps each time the medicaments are ingested.

24. The method as claimed in claim 23, further comprising the act of removing the circular shaped affixable label from a holding strip before the act of placing the label on a portion of a medicament container.

25. The method as claimed in claim 23, wherein the act of completing information on a preprinted circular shaped affixable label includes completing date information, time of day information, medicament information, and dose information.

26. The method as claimed in claim 23, wherein the act of completing information on a preprinted circular shaped affixable label includes completing medicament information, dose information, and timetable information.

27. The method as claimed in claim 23, wherein the act of completing information on a preprinted circular shaped affixable label is completed after the act of placing the label on a portion of a medicament container.

28. A method of tracking a schedule of taking a medicament, the method comprising:
(a) completing medicament information and dose information on a first side of a preprinted affixable label, the affixable label also having a second side operable to be affixed to a portion of a medicament container, a perimeter, and a predetermined thickness such that the label may be peeled from a backing sheet, the affixable label having a time indicator positioned relatively near the perimeter;
(b) marking one or more times of day the medicament is to be taken on the time indicator;
(c) placing the label on the portion of a medicament container; and
(d) repeating steps (a)-(c) upon the occurrence of a predetermined condition.

29. The method as claimed in claim 28, wherein the predetermined condition is a predetermined amount of time.

30. The method as claimed in claim 28, wherein the predetermined condition is a change in the schedule.

31. The method as claimed in claim 28, wherein the predetermined condition is a change in at least one of the medic ament and the dose information.

32. The method as claimed in claim 28, further comprising the act of removing the affixable label from a backing strip after the act of completing medic ament and dose information on the preprinted affixable label.

33. The method as claimed in claim 28, wherein acts (a)-(c) are performed in any order.

34. A method of tracking a schedule of taking a medicament, the method comprising:
determining a schedule for taking a medicament,
translating the schedule for taking the medic ament to a preprinted affixable label, the preprinted affixable label having a first side that includes a plurality of preprinted texts, at least two of the preprinted texts having an associated preprinted line, where a first of the at least two preprinted lines relates to a type of the medic ament, and a second of the at least two preprinted lines relates to a dosage of the medicament, and a second side operable to be affixed to a portion of a medicament container, where the act of translating the schedule is accomplished by marking at least some of the preprinted texts with at least one first mark to indicate at least one time of day the medicament is to be consumed;
marking at least some of the preprinted text with at least one second mark to indicate at least one time of day when the medicament was actually consumed;
placing a second label over the preprinted affixable label when a predetermined condition occurs.

35. The method as claimed in claim 34, wherein the predetermined condition is a predetermined amount of time.

36. The method as claimed in claim 35, wherein the predetermined amount of time is 24 hours.

37. The method as claimed in claim 34, further comprising determining a second schedule for taking a medicament, translating the second schedule for taking the medicament to the second label.

38. The method as claimed in claim 37, wherein the second schedule is substantially similar to the first mentioned schedule.

39. The method as claimed in claim 37, wherein the second schedule is different than the first mentioned schedule.

40. The method as claimed in claim 34, further comprising completing medicament information and dose information on the first side of the first mentioned label and on the second label.

41. The method as claimed in claim 34, further comprising placing the first mentioned label on a portion of a medicament container.

42. The method as claimed in claim 34, wherein the first side further includes a third preprinted line that relates to a name of a consumer of the medicament.

43. The method as claimed in claim 42, wherein the first side includes a fourth reprinted line that relates to a date of a schedule.

44. The method as claimed in claim 34, wherein the at least one first mark and the at least one second mark are marked on a timetable that includes a plurality of numbers.

45. The method as claimed in claim 44, wherein the plurality of numbers includes two sets of numbers, each set of numbers ranging from 1 through 12, the time indicator further including an AM/PM indicator.

46. The method as claimed in claim 44, wherein the plurality of numbers includes numbers ranging from 1 through 24.
